(19) United States
(12) Patent Application Publication
(10) Pub. No.: US 2016/0234086 A1
(43) Pub. Date: Aug. 11, 2016

(54) COMPUTING DEVICE AND METHOD FOR SUBMITTING USER INFORMATION

(71) Applicant: Chiun Mai Communication Systems, Inc., New Taipei (TW)

(72) Inventor: BO-CHIH HU, New Taipei (TW)

(21) Appl. No.: 14/843,515

(22) Filed: Sep. 2, 2015

(30) Foreign Application Priority Data
Feb. 9, 2015 (CN) 201510068416.1

(51) Int. Cl. H04L 12/26; H04W 12/08

(52) U.S. Cl. CPC H04L 43/08; H04W 12/08

(57) ABSTRACT

In a user information submitting method executed in a computing device, if a preset operation performed in the computing device is detected, a request of obtaining user information related to the preset operation is generated. The generated request is transmitted to an external electronic device, and the user information stored in the external electronic device is inquired. The inquired user information is received by the computing device, and the preset operation is executed according to the inquired user information.

### CROSS-REFERENCE TO RELATED APPLICATIONS

This application claims priority to Chinese Patent Application No. 201510068416.1 filed on Feb. 9, 2015, the contents of which are incorporated by reference herein.

### FIELD

The subject matter herein generally relates to electronic devices, and particularly to a computing device capable of automatically submitting user information.

### BACKGROUND

Some operations are redundantly repeated every day. The operations include online payment, login applications, and the like. Many redundantly repeated operations require a user to submit personal information.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a user information submitting system.

FIG. 2 is a block diagram of one example embodiment of function modules of the user information submitting system in FIG. 1.

FIG. 3 is a flowchart of one example embodiment of a user information submitting method.

FIG. 4 is a block diagram of one example embodiment of the user information.

FIG. 5 is a flowchart of one example embodiment of an application login method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

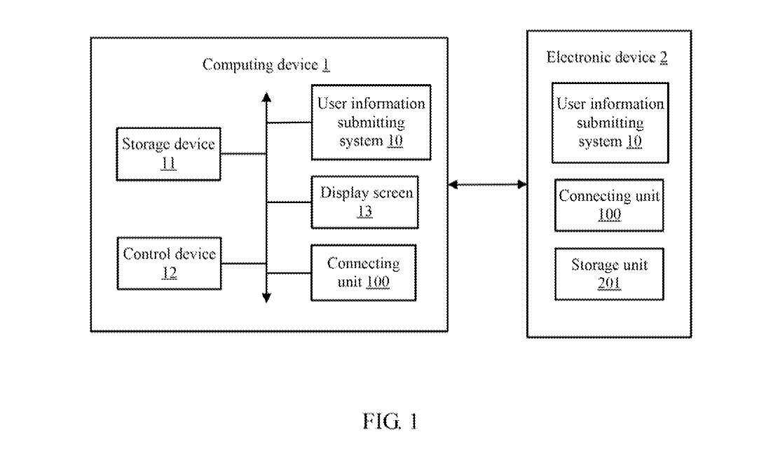

FIG. 1 is a block diagram of one example embodiment of a hardware environment for executing a user information submitting system 10. In at least one embodiment, the user information submitting system 10 is installed in and run by a computing device 1 and an electronic device 2. The computing device 1 can be a smart phone, a computer, a personal digital assistant, and the like. The computing device 1 can include, but is not limited to, a storage device 11, at least one control device 12, a display screen 13, and a connecting unit 100. The electronic device 2 can be a universal serial bus (USB) flash disk, a smart phone, a near field communication (NFC) sensor, and the like. The electronic device 2 can include, but is not limited to, a storage unit 201, a connecting unit 100, and the like. In the embodiment, the computing device 1 is connected with the electronic device 2 by the connecting unit 100, so that the computing device 1 can communicate with the electronic device 2 through the connecting unit 100. FIG. 1 illustrates only one example of the hardware environment that can include more or fewer components than illustrated, or have a different configuration of the various components in other embodiments.

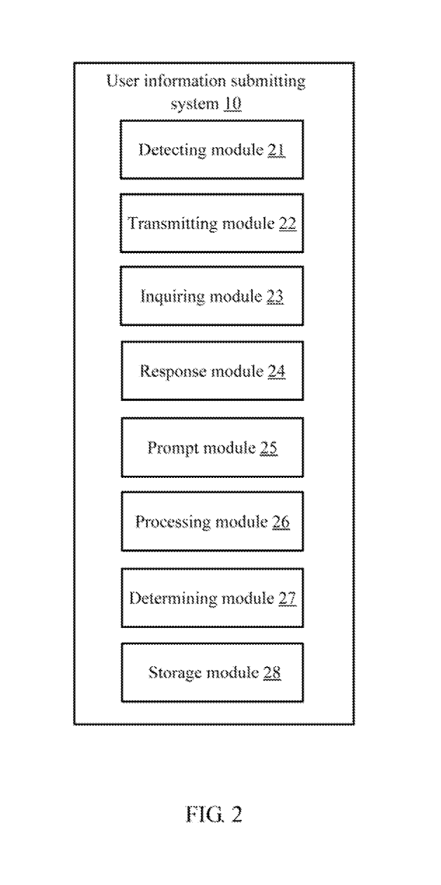

In at least one embodiment, the storage device 11 and the storage unit 201 can include various types of non-transitory computer-readable storage media. For example, the storage device 11 and the storage unit 201 can be an internal storage system, such as a flash memory, a random access memory (RAM) for temporary storage of information, and/or a read-only memory (ROM) for permanent storage of information. The storage device 11 and the storage unit 201 can also be an external storage system, such as a hard disk, a storage card, or a data storage medium. In the embodiment, the user information submitting system 10 can include a plurality of function modules (shown in FIG. 2). The storage device 11 and the storage unit 201 can store the computerized codes of the function modules of the user information submitting system 10. The at least one control device 12 can be a central processing unit (CPU), a digital signal processor, a single chip, an application-specific integrated circuit (ASIC), or a field programmable gate array (FPGA), for example. The at least one control device 12 can execute computerized codes of the function modules of the user information submitting system 10 to realize the functions of the computing device 1. The display screen 13 can be a liquid crystal display (LCD), an organic light-emitting diode (OLED) display, or the like. The connecting unit 100 can include, but is not limited to, intranet, internet, global system of mobile communication (GSM), wideband code division multiple access (WCDMA), Wi-Fi, BLUETOOTH, NFC, USB connector, and the like.

FIG. 2 is a block diagram of one embodiment of function modules of the user information submitting system 10. The function modules can include, but are not limited to, a detecting module 21, a transmitting module 22, an inquiring module 23, a response module 24, a prompt module 25, a processing module 26, a determining module 27, and a storage module 28. In the embodiment, the function modules 21-22 and 25-27 are executed in the computing device 1, the function modules 23-24 and 28 are executed in the electronic device 2. The function modules 21-28 can include computerized codes in the form of one or more programs, which can provide at least the functions of the user information submitting system 10.

The detecting module 21 detects a preset operation when the computing device 1 is operated. In at least one embodiment, the preset operation may be a login operation, an online payment operation, an unlocking operation, or the like.

When the preset operation is detected, the transmitting module 22 generates a request of obtaining user information related to the preset operation in the computing device 1, and transmits the generated request to the electronic device 2 through the connecting unit 100.

In at least one embodiment, the generated request can include, but is not limited to, a request of obtaining a login identification (ID) and password of an application (e.g., QQ® application or WeChat® application) which is installed in the computing device 1, a request of obtaining an account name and password for online payment, a request of obtaining an unlocking password of the computing device 1, and the like. For example, the generated request can be a request of obtaining a login ID and password of the QQ® application when the QQ® application is operated.

The inquiring module 23 inquires the user information related to the preset operation in the storage unit 201 of the electronic device 2 when receiving the request transmitted by the computing device 1.

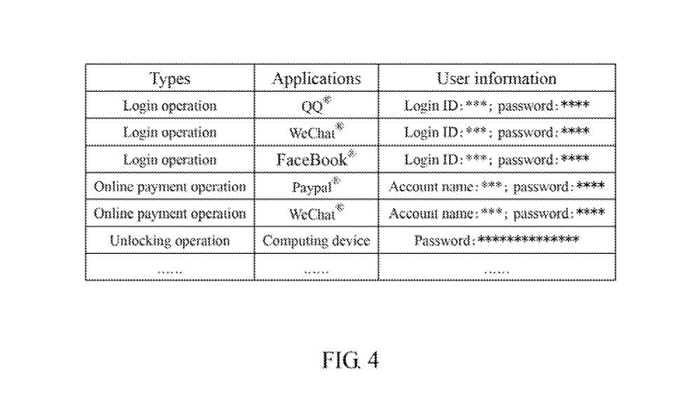

In at least one embodiment, information related to various preset operations is pre-stored in the storage unit 201. As shown in FIG. 4, the pre-stored information can be stored in a data table, the data table can include, but is not limited to, types of the preset operations (e g., login operation, online payment operation, or unlocking operation), applications related to the preset operations (e.g., the QQ® application, the WeChat® application, FaceBook® application, Paypal application), and user information related to the preset operations (e.g., login IDs and passwords of the applications, account names and passwords for online payment, or unlocking passwords). Thus, the inquiring module 23 can inquire the user information related to the preset operation from the data table. In detail, if the request transmitted by the computing device 1 is a request of obtaining the login ID and password of the QQ® application, the inquire module 23 can first inquire the login operations from the data table, second inquire the login operation related to the QQ® application from the inquired login operations, and finally inquire the user information (the login ID and password) of the QQ® application.

When the user information related to the preset operation is inquired in the storage unit 201, the response module 24 sends the inquired user information to the computing device 1.

When the user information related to the preset operation is not inquired in the storage unit 201, the prompt module 25 displays a prompt on the display screen 13 of the computing device 1 to request the user of the computing device 1 to input the user information manually.

The processing module 26 receives the user information related to the preset operation, and executes the preset operation according to the received user information. In at least one embodiment, the received user information can be the user information inquired in the storage unit 201 of the electronic device 2 or the user information input manually by the user of the computing device 1.

The determining module 27 determines whether the preset operation is executed successfully. If the preset operation is not executed successfully, the prompt module 25 prompts the user of the computing device 1 to input the user information manually on the display screen 13.

If the preset operation is executed successfully, the transmitting module 22 transmits the received user information to the electronic device 2, and the storage module 28 stores the received user information in the storage unit 201 of the electronic device 2. In at least one embodiment, the received user information can be encrypted when stored in the storage unit 201.

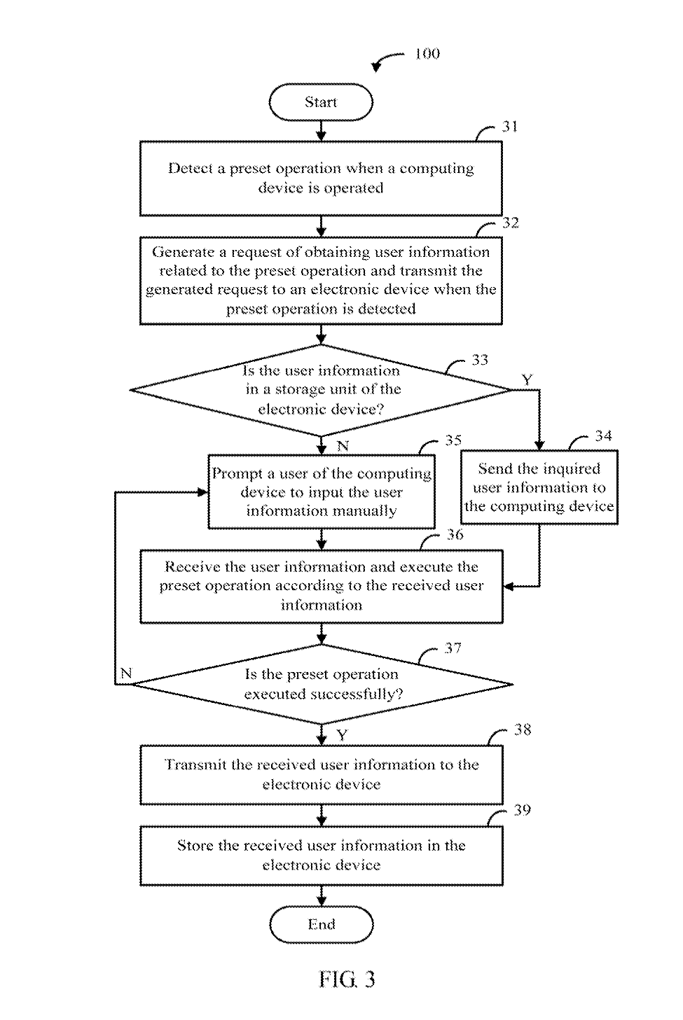

FIG. 3 illustrates an embodiment of a method 100 for submitting user information. In the embodiment, the method 100 is provided by way of example, as there are a variety of ways to carry out the method 100. The method 100 described below can be carried out using the configurations illustrated in FIGS. 1 and 2, for example, and various elements of these figures are referenced in the explanation of the method 100. Each block shown in FIGS. 1 and 2 represents one or more processes, methods, or subroutines carried out in the method 100. Additionally, the illustrated order of blocks is by example only and the order of the blocks can change. The method 100 can begin at block 31.

At block 31, a detecting module detects a preset operation when a computing device is operated. In at least one embodiment, the preset operation may be a login operation, an online payment operation, an unlocking operation, or the like.

At block 32, when the preset operation is detected, a transmitting module generates a request of obtaining user information related to the preset operation in the computing device, and transmits the generated request to an electronic device. In at least one embodiment, the generated request can include, but is not limited to, a request of obtaining a login ID and password of an application which is installed in the computing device, a request of obtaining an account name and password for online payment, a request of obtaining an unlocking password of the computing device, and the like.

At block 33, an inquiring module inquires the user information related to the preset operation in a storage unit of the electronic device when receiving the request transmitted by the computing device. If the user information related to the preset operation is inquired, block 34 is implemented. If the user information related to the preset operation is not inquired, block 35 is implemented.

At block 34, a response module sends the inquired user information to the computing device.

At block 35, a prompt module displays a prompt on a display screen of the computing device to request the user of the computing device to input the user information manually.

At block 36, a processing module receives the user information related to the preset operation, and executes the preset operation according to the received user information. In at least one embodiment, the received user information can be the user information inquired in the storage unit of the electronic device or the user information input manually by the user of the computing device.

At block 37, a determining module determines whether the preset operation is executed successfully. If the preset operation is not executed successfully, block 35 is repeated; if the preset operation is executed successfully, block 38 is implemented.

At block 38, the transmitting module transmits the received user information to the electronic device.

At block 39, a storage module stores the received user information in the storage unit of the electronic device. In at least one embodiment, the received user information can be encrypted when stored in the storage unit.

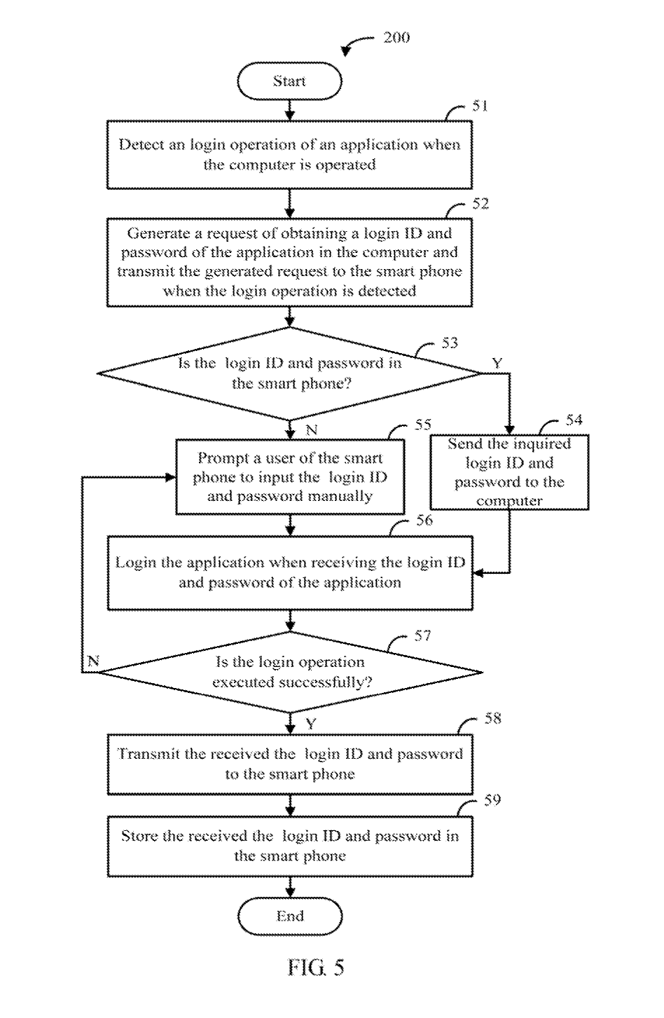

FIG. 5 is a flowchart of one example embodiment of the method 200 for login to applications. In the embodiment, the computing device is a computer, the electronic device is a smart phone, and the computer is connecting with the smart phone by a USB connector. The preset operations is a login operation of an application which is installed in the computer. Detailed description of the method 200 is as follows:

At block 51, the detecting module detects a login operation of an application when the computer is operated.

At block 52, when the login operation is detected, the transmitting module generates a request of obtaining a login ID and password of the application in the computer, and transmits the generated request to the smart phone.

At block 53, the inquiring module inquires the login ID and password of the application in the smart phone when receiving the generated request. If the login ID and password of the application is inquired, block 54 is implemented. If the login ID and password of the application is not inquired, block 55 is implemented.

At block 54, the response module sends the inquired login ID and password of the application to the computer.

At block 55, the prompt module displays a prompt on the display screen of the computer to request the user to input the login ID and password of the application manually.

At block 56, the processing module logins to the application when receiving the login ID and password of the application. In the embodiment, the received login ID and password of the application can be inquired in the smart phone or input manually by the user of the computer.

At block 57, the determining module determines whether the login operation is executed successfully. If the login operation is not executed successfully, block 55 is repeated. If the login operation is executed successfully, block 58 is implemented.

At block 58, the transmitting module transmits the received login ID and password of the application to the smart phone.

At block 59, the storage module stores the received login ID and password of the application in the smart phone. In at least one embodiment, the received login ID and password of the application can be encrypted when being stored in the smart phone.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A user information submitting method being executed by at least one control device of a computing device, the method comprising:
detecting a preset operation performed in the computing device;
generating, in response to the detecting, a request for user information related to the preset operation;
transmitting the generated request to an external electronic device;
receiving, following the transmitting, the user information returning from the external electronic device; and
executing the preset operation according to the received user information.

2. The method according to claim 1, further comprising:
sending the received user information to the external electronic device to store the received user information in the external electronic device when the preset operation is executed successfully.

3. The method according to claim 1, further comprising:
displaying a prompt of inputting the user information manually on a display screen of the computing device when the user information is not returned from the external electronic device or the preset operation is not executed successfully.

4. The method according to claim 1, wherein the preset operation is a login operation, an online payment operation, or an unlocking operation.

5. The method according to claim 1, wherein the computing device is connected with the external electronic device by a Wi-Fi connector, a BLUETOOCH connector, an NFC connector, or a USB connector.

6. The method according to claim 2, wherein the received user information is encrypted when stored in the external electronic device.

7. A computing device comprising:
a display screen;
at least one control device; and
a storage device storing one or more programs which when executed by the at least one control device, causes the at least one control device to perform operations comprising:
detecting a preset operation performed in the computing device;
generating, in response to the detecting, a request for user information related to the preset operation;
transmitting the generated request to an external electronic device;
receiving, following the transmitting, the user information returning from the external electronic device; and
executing the preset operation according to the received user information.

8. The computing device according to claim 7, wherein the operations further comprise:
sending the received user information to the external electronic device to store the received user information in the external electronic device when the preset operation is executed successfully.

9. The computing device according to claim 7, wherein the operations further comprise:
displaying a prompt of inputting the user information manually on a display screen of the computing device when the user information is not returned from the external electronic device or the preset operation is not executed successfully.

10. The computing device according to claim 7, wherein the preset operation is a login operation, an online payment operation, or an unlocking operation.

11. The computing device according to claim 7, wherein the computing device is connected with the external electronic device by a Wi-Fi connector, a BLUETOOCH connector, an NFC connector, or a USB connector.

12. The computing device according to claim 8, wherein the received user information is encrypted when stored in the external electronic device.

13. A non-transitory computer-readable storage medium having stored thereon instructions that, when executed by at least one control device of a computing device, causes the at least one control device to perform a user information submitting method, the method comprising:
detecting a preset operation performed in the computing device;
generating, in response to the detecting, a request for user information related to the preset operation;
transmitting the generated request to an external electronic device;
receiving, following the transmitting, the user information returning from the external electronic device; and
executing the preset operation according to the received user information.

14. The non-transitory computer-readable storage medium according to claim 13, wherein the method further comprises:
sending the received user information to the external electronic device to store the received user information in the external electronic device when the preset operation is executed successfully.

15. The non-transitory computer-readable storage medium according to claim 13, wherein the method further comprises:
displaying a prompt of inputting the user information manually on a display screen of the computing device when the user information is not returned from the external electronic device or the preset operation is not executed successfully.

16. The non-transitory computer-readable storage medium according to claim 13, wherein the preset operation is a login operation, an online payment operation, or an unlocking operation.

17. The non-transitory computer-readable storage medium according to claim 13, wherein the computing device is connected with the internal electronic device by a Wi-Fi connector, a BLUETOOCH connector, an NFC connector, or a USB connector.

18. The non-transitory storage medium according to claim 14, wherein the received user information is encrypted when stored in the external electronic device.
